(19) United States
(12) Patent Application Publication
(10) Pub. No.: US 2013/0098656 A1
(43) Pub. Date: Apr. 25, 2013

(54) POLYIMIDE RESIN VARNISH, AND INSULATED WIRE, ELECTRICAL COIL, AND MOTOR USING SAME

(71) Applicants: Hideaki Saito, Osaka-shi (JP); Jun Sugawara, Osaka-shi (JP); Masaaki Yamauchi, Koka-shi (JP); Kengo Yoshida, Koka-shi (JP); Yuji Hatanaka, Koka-shi (JP)

(72) Inventors: Hideaki Saito, Osaka-shi (JP); Jun Sugawara, Osaka-shi (JP); Masaaki Yamauchi, Koka-shi (JP); Kengo Yoshida, Koka-shi (JP); Yuji Hatanaka, Koka-shi (JP)

(73) Assignees: SUMITOMO ELECTRIC INDUSTRIES, LTD., Osaka-shi, Osaka (JP); SUMITOMO ELECTRIC WINTEC, INC., Koka-shi, Shiga (JP)

(21) Appl. No.: 13/807,616

(22) PCT Filed: Jan. 17, 2012
(86) PCT No.: PCT/JP2012/050782

§ 371 Date: Dec. 28, 2012

(30) Foreign Application Priority Data
Jan. 28, 2011 (JP) 2011-016219

(51) Int. Cl. H01B 3/30; C09D 179/08

(52) U.S. Cl. CPC H01B 3/306; C09D 179/08
USPC 174/110 SR; 524/600

(57) ABSTRACT

Provided is an insulated wire that can realize a high corona inception voltage and that can satisfy required properties such as heat resistance and a mechanical strength. A polyimide resin varnish containing, as a main component, a polyimide precursor resin obtained by allowing an aromatic diamine to react with an aromatic tetracarboxylic dianhydride, wherein the aromatic diamine includes a first aromatic diamine having an aromatic ether bond and three or more benzene rings, and a second aromatic diamine represented by formula (2) below, and an imide group concentration after imidization of the polyimide precursor resin is 25% or more and 35% or less.

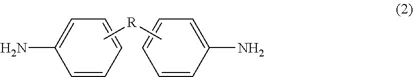

(In the formula, R represents CH₂ or O.)

### TECHNICAL FIELD

The present invention relates to a polyimide resin varnish that can form an insulating film by being applied onto a conductor and being baked, an insulated wire including an insulating layer formed using the polyimide resin varnish, and an electrical coil and a motor that use the insulated wire.

### BACKGROUND ART

In an insulated wire used as a winding for a coil of a motor or the like, an insulating layer (insulating film) that covers a conductor requires good insulating performance, adhesiveness to the conductor, heat resistance, mechanical strength, etc. Examples of a resin used for forming the insulating layer include polyimide resins, polyamide-imide resins, and polyester-imide resins.

In electrical equipment to which a high voltage is applied, for example, a motor that is used at a high voltage, a high voltage is applied to an insulated wire constituting the electrical equipment, and partial discharge (corona discharge) is easily generated on a surface of an insulating film of the insulated wire. The generation of corona discharge easily causes a local increase in the temperature and generation of ozone and ions. As a result, the insulating film of the insulated wire is degraded, resulting in dielectric breakdown at an early stage. Consequently, the lifetime of the electrical equipment is shortened. An improvement in the corona inception voltage is also required for such an insulated wire used at a high voltage for the above reason. It is known that lowering the dielectric constant of the insulating layer is effective for this purpose.

Polyimide resins are materials having good heat resistance and relatively low dielectric constants. However, polyimide resins have a problem in that they have a small tensile elongation at break and low flexibility due to the rigid structure thereof. A coil used in a motor may be subjected to a process of significantly deforming an insulated wire in order to increase the lamination factor, for example, a process of winding an insulated wire to form a coil, and then inserting the coil in a slot. In this case, when an insulating layer has low flexibility, the insulating film gets easily damaged during the process, which may result in degradation of electrical properties and generation of cracks in the insulating film.

PTL 1 describes a polyimide resin having an aromatic ether structure. Specifically, a polyimide precursor is synthesized by allowing an acid anhydride having an aromatic ether structure, such as 4,4′-oxydiphthalic dianhydride (ODPA), to react with a diamine having an aromatic ether structure and a diamine having a fluorene structure. By using the acid anhydride and the diamine that have an aromatic ether structure, flexibility is improved. PTL 1 also describes that a polyimide resin having such a structure has a low dielectric constant, and thus can provide an insulating film that is good in terms of the suppression of the corona generation.

### CITATION LIST

### Patent Literature

PTL 1: Japanese Unexamined Patent Application Publication No. 2010-67408

### SUMMARY OF INVENTION

### Technical Problem

Although the introduction of an aromatic ether structure in the molecular structure of a polyimide resin improves the flexibility of a coating film, it causes a problem in that heat resistance of the polyimide resin is lower than that of polyimide resins in which no aromatic ether structure is introduced. For example, the glass transition temperatures of polyimide resins described in Examples of PTL 1 are 265° C. to 302° C., which are lower than the glass transition temperature of typical polyimides (about 400° C.).

The present invention has been made in view of the above problem, and an object of the present invention is to provide a polyimide resin varnish that can form an insulating film, the flexibility of which is increased to improve processing resistance without decreasing heat resistance. Another object of the present invention is to provide an insulated wire that includes an insulating layer formed by using the polyimide resin varnish and that can satisfy required properties such as heat resistance and a mechanical strength, and an electrical coil and a motor that use the insulated wire.

### Solution to Problem

The present invention provides a polyimide resin varnish containing, as a main component, a polyimide precursor resin obtained by allowing an aromatic diamine to react with an aromatic tetracarboxylic dianhydride,
wherein the aromatic diamine includes
a first aromatic diamine having an aromatic ether bond represented by formula (1) below and three or more in total selected from a benzene ring and a naphthalene ring, and
a second aromatic diamine represented by formula (2) below, and
an imide group concentration after imidization of the polyimide precursor resin is 25% or more and 35% or less (claim 1).

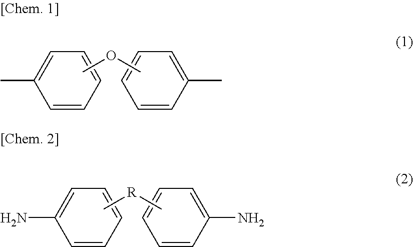

(In the formula, R represents CH₂ or O.)

In order to increase flexibility of the polyimide resin, a first aromatic diamine having an aromatic ether structure and three or more in total selected from a benzene ring and a naphthalene ring is used. The first aromatic diamine has three or more selected from a benzene ring and a naphthalene ring, and thus is a flexible component having a high molecular weight. A second aromatic diamine having two benzene rings is used in combination with the first aromatic diamine. By using the second aromatic diamine in combination, the strength of the polyimide resin can be increased.

In addition, the inventors of the present invention focused on an imide group concentration of a polyimide resin. The imide group concentration is a value calculated by the formula

(molecular weight of imide group moiety)/(molecular weight of whole polymer)×100(%)

in a polyimide resin after imidization of a polyimide precursor. Since the polyimide precursor is obtained by allowing an aromatic diamine to react with an aromatic tetracarboxylic dianhydride, the imide group concentration is decreased when the molecular weight of each monomer (the aromatic diamine or the aromatic tetracarboxylic dianhydride) is increased. When the imide group concentration is lower than 25%, heat resistance tends to decrease. When the imide group concentration is higher than 35%, flexibility tends to decrease. By controlling the imide group concentration in the range of 25% or more and 35% or less, a polyimide resin having balanced heat resistance and flexibility can be obtained.

The first aromatic diamine used in the invention of the present application has a high molecular weight. Accordingly, when the molecular weight of the aromatic tetracarboxylic dianhydride used in combination with the first aromatic diamine is also high, the imide group concentration of the whole polyimide resin is decreased, thereby decreasing heat resistance. By using the first aromatic diamine and the second aromatic diamine as a diamine component and using an aromatic tetracarboxylic dianhydride component having a molecular weight that achieves an imide group concentration of 25% or more and 35% or less, a polyimide resin having both high heat resistance and high flexibility can be obtained. Furthermore, since the concentration of an imide group, which has a high polarity, is lower than the imide group concentration (36.6%) of a typical polyimide resin such as Kapton, a polyimide having a low dielectric constant can be obtained.

The aromatic tetracarboxylic dianhydride is preferably pyromellitic dianhydride (hereinafter referred to as “PMDA”) (claim 2). Pyromellitic dianhydride has a relatively low molecular weight and a rigid structure. Therefore, even when a flexible component having a high molecular weight is selected as the first aromatic diamine, the imide group concentration of the resulting polyimide can be made 25% or more and 35% or less. Thus, both high flexibility and high heat resistance of the polyimide resin can be realized.

The first aromatic diamine is preferably at least one selected from the group consisting of 2,2-bis[4-(aminophenoxy)phenyl]propane, 1,1-bis[4-(4-aminophenoxy)phenyl]cyclohexane, 1,3-bis(4-aminophenoxy)benzene, and 1,4-bis(4-aminophenoxy)benzene (claim 3). These aromatic diamines each have a high molecular weight, and thus flexibility of the polyimide resin can be improved. In particular, when PMDA is selected as the acid anhydride, the use of any of these aromatic diamines is preferable because flexibility, heat resistance, and a mechanical strength (tensile strength) are balanced with each other.

A content ratio (molar ratio) of the first aromatic diamine to the second aromatic diamine is preferably 30:70 to 90:10 (claim 4). The content ratio is more preferably 50:50 to 80:20. When the amount of first aromatic diamine is smaller than this range, the elongation of the polyimide resin is small, and flexibility may be insufficient. When the amount of second aromatic diamine is smaller than this range, defects such as pinholes tend to be generated in the resulting polyimide resin coating film and sufficient toughness is not easily obtained.

An invention according to claim 5 provides an insulated wire including a conductor and an insulating layer that covers the conductor either directly or with another layer therebetween, wherein the insulating layer is formed by applying the polyimide resin varnish and baking the polyimide resin varnish. Since the insulated wire includes an insulating layer composed of a polyimide having good heat resistance and a good tensile strength in addition to good flexibility, an insulated wire having good processing resistance and heat resistance can be obtained. Furthermore, since the insulating layer has a low dielectric constant, an insulated wire having a high corona inception voltage can be obtained.

An invention according to claim 6 provides an electrical coil obtained by winding the insulated wire. An invention according to claim 7 provides a motor including the electrical coil according to claim 6. Since the insulated wire having good processing resistance and heat resistance is used, a coil having a high lamination factor can be obtained, and the reduction in the sizes of the coil and the motor can be realized. Furthermore, even when a high voltage is applied, degradation of an insulating film does not easily occur, and thus the lifetime can be extended.

### Advantageous Effects of Invention

According to the present invention, it is possible to provide a polyimide resin varnish for an insulated wire having good flexibility, a good mechanical strength such as a tensile strength, and good heat resistance. The insulated wire of the present invention can satisfy required properties such as heat resistance and a mechanical strength and can improve the corona inception voltage.

### BRIEF DESCRIPTION OF DRAWINGS

FIG. 1 is a schematic view illustrating a method for measuring a dielectric constant.

FIG. 2 is a cross-sectional schematic view illustrating an example of an insulated wire of the present invention.

FIG. 3A is a schematic view illustrating an example of a coil of the present invention.

FIG. 3B is a schematic view illustrating an example of a coil of the present invention and is a cross-sectional view taken along line A-A′ of FIG. 3A.

FIG. 4 is a schematic view illustrating an example of a motor of the present invention.

### DESCRIPTION OF EMBODIMENTS

A polyimide precursor resin (polyamic acid), which is a main component of a polyimide resin varnish of the present invention, is obtained by condensation polymerization of an aromatic tetracarboxylic dianhydride and an aromatic diamine. This condensation polymerization reaction can be conducted under the same conditions as those in the synthesis of known polyimide precursors.

Examples of the aromatic tetracarboxylic dianhydride include pyromellitic dianhydride (PMDA), 4,4′-oxydiphthalic dianhydride (ODPA), 3,4,3′,4′-biphenyltetracarboxylic dianhydride (BPDA), 3,3′,4,4′-benzophenonetetracarboxylic dianhydride (BTDA), 3,3′,4,4′-diphenylsulfonetetracarboxylic dianhydride, bicyclo(2,2,2)-octo-7-ene-2,3,5,6-tetracarboxylic dianhydride, 1,2,4,5-cyclohexanetetracarboxylic dianhydride, 2,2-bis(3,4-dicarboxyphenyl)hexafluoropropane dianhydride, and 5-(2,5-dioxotetrahydrofuryl)-3-methyl-3-cyclohexene-1,2-dicarboxylic dianhydride.

Among these, pyromellitic dianhydride (PMDA) represented by formula (3) below is preferable from the standpoint that heat resistance of the resulting polyimide resin can be improved because PMDA has a low molecular weight and a rigid structure.

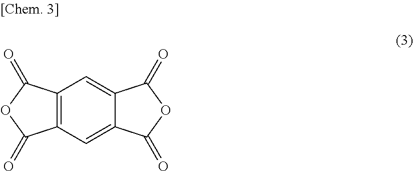 [SMILES: O=c1oc(=O)c2cc3c(=O)oc(=O)c3cc12]

As the aromatic diamine, a first aromatic diamine and a second aromatic diamine are used in combination. As the first aromatic diamine, an aromatic diamine having an aromatic ether bond and three or more in total selected from a benzene ring and a naphthalene ring is used. Examples of the first aromatic diamine include 2,2-bis[4-(aminophenoxy)phenyl]propane (BAPP), which has four benzene rings; 1,1-bis[4-(4-aminophenoxy)phenyl]cyclohexane (4-APBZ), which has four benzene rings; 1,3-bis(4-aminophenoxy)benzene (TPE-R), which has three benzene rings; 1,4-bis(4-aminophenoxy)benzene (TPE-Q), which has three benzene rings; 1,3-bis(3-aminophenoxy)benzene (3-APB), which has three benzene rings; and 1,5-bis(3-aminophenoxy)naphthalene (1,5-BAPN), which has two benzene rings and one naphthalene ring. The use of a molecule having a large number of aromatic ether bonds therein increases the effect of improving the flexibility.

Among these, 2,2-bis[4-(aminophenoxy)phenyl]propane (BAPP), which is represented by formula (4) below; 1,1-bis[4-(4-aminophenoxy)phenyl]cyclohexane (4-APBZ), which is represented by formula (5) below; 1,3-bis(4-aminophenoxy)benzene (TPE-R), which is represented by formula (6) below; and 1,4-bis(4-aminophenoxy)benzene (TPE-Q) can be preferably used.

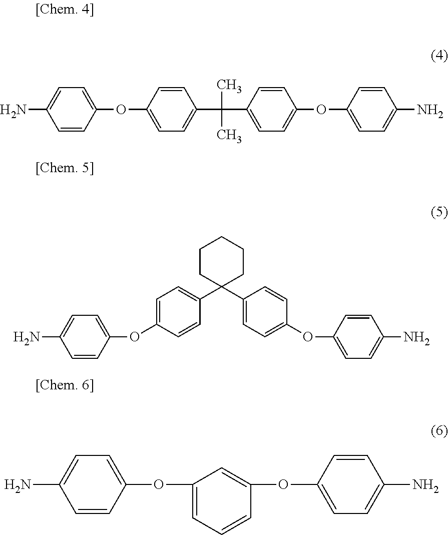 [SMILES: CC(C)(c1ccc(Oc2ccc(N)cc2)cc1)c1ccc(Oc2ccc(N)cc2)cc1 ; Nc1ccc(Oc2ccc(C3(c4ccc(Oc5ccc(N)cc5)cc4)CCCCC3)cc2)cc1 ; Nc1ccc(Oc2cccc(Oc3ccc(N)cc3)c2)cc1]

As the second aromatic diamine, an aromatic diamine having two benzene rings and represented by formula (2) below is used. Specifically, 4,4′-methylenedianiline (MDA), which is represented by formula (7) below, and 4,4′-diaminodiphenyl ether (ODA), which is represented by formula (8) below can be preferably used.

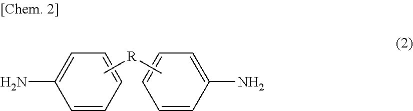

(In the formula, R represents CH₂ or O.)

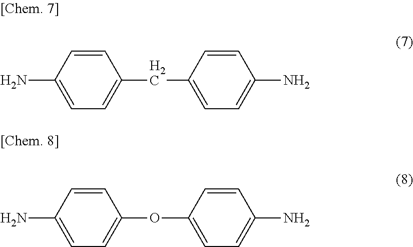 [SMILES: Nc1ccc(Cc2ccc(N)cc2)cc1 ; Nc1ccc(Oc2ccc(N)cc2)cc1]

The aromatic tetracarboxylic dianhydride, the first aromatic diamine, and the second aromatic diamine are selected so that an imide group concentration after imidization is 25% or more and 35% or less. The imide group concentration is a value calculated by the formula

(molecular weight of imide group moiety)/(molecular weight of whole polymer)×100

in a polyimide resin after imidization of a polyimide precursor. The imide group concentration is specifically calculated by the following method.

The imide group concentration per unit is calculated from the molecular weights of an aromatic tetracarboxylic dianhydride and an aromatic diamine. For example, in the case of a polyimide represented by formula (9) below, the imide group concentration is calculated as follows.
Imide group molecular weight=70.03×2=140.06
Unit molecular weight=894.96
Therefore,

Imide group concentration (%)=(140.06)/(894.96)×100=15.6%
The imide group concentration of a unit containing the first aromatic diamine and the imide group concentration of a unit containing the second aromatic diamine are respectively determined. The imide group concentration of the unit containing the first aromatic diamine is multiplied by the content ratio of the first aromatic diamine, and the imide group concentration of the unit containing the second aromatic diamine is multiplied by the content ratio of the second aromatic diamine. Thus, the imide group concentration of the whole polyimide is calculated.

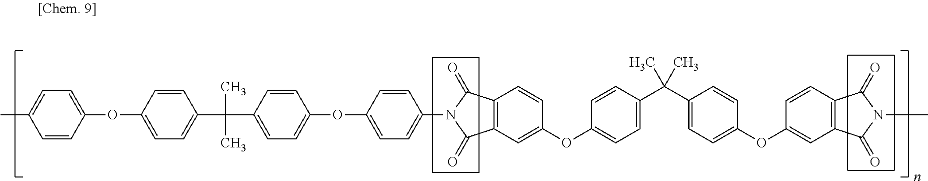

The aromatic tetracarboxylic dianhydride, the first aromatic diamine, and the second aromatic diamine are mixed and allowed to react with each other. A mixing ratio of the first aromatic diamine to the second aromatic diamine is 30:70 to 90:10 (molar ratio). The mixing ratio is more preferably 50:50 to 80:20. In addition, a ratio of the total amount (equivalent) of aromatic diamines to the total amount (equivalent) of aromatic tetracarboxylic dianhydride is preferably about 1:1 from the standpoint that the reaction satisfactorily proceeds. An acid anhydride component and a diamine component other than the aromatic tetracarboxylic dianhydride, the first aromatic diamine, and the second aromatic diamine may be used in combination as long as the objects of the present invention are not impaired. These materials are mixed, and the resulting mixture is allowed to react by heating in an organic solvent. Thus, a polyimide precursor resin is prepared.

Aprotic polar organic solvents such as N-methyl-2-pyrrolidone, N,N-dimethylformamide, N,N-dimethylacetamide, dimethyl sulfoxide, and γ-butyrolactone can be used as the organic solvent. These organic solvents may be used alone or in combination of two or more solvents.

The amount of organic solvent is not particularly limited as long as the aromatic acid anhydride component and the aromatic diamine component etc. can be uniformly dispersed in the organic solvent. However, the organic solvent is usually used in an amount of 100 parts by mass to 1,000 parts by mass relative to 100 parts by mass of the total amount of these components (so that the resin concentration is about 10% to 50%). Reducing the amount of organic solvent increases the solid content of the resulting polyimide resin varnish, and this is effective to reduce the cost.

Various additives such as a pigment, a dye, an inorganic or organic filler, a lubricant, and an adhesion improver, a reactive low-molecular-weight compound, a compatibilizer, and the like may be added to the polyimide resin varnish. Furthermore, other resins may be mixed within a range that does not impair the objects of the present invention.

The polyimide resin varnish is applied onto a conductor either directly or with another layer therebetween, and is then baked to form an insulating layer. The polyimide precursor resin is imidized in the step of baking and converted into a polyimide. The application and the baking can be conducted as in the production of a typical insulated wire. For example, a resin varnish is applied onto a conductor, and a step of baking the resin varnish by passing the conductor through a furnace set at a temperature of 350° C. to 500° C. for 5 to 10 seconds per pass is repeated several times to form an insulating layer. The thickness of the insulating layer is 10 to 150 μm.

For example, copper, copper alloys, and aluminum can be used as the conductor. The size and the cross-sectional shape of the conductor are not particularly limited. In the case of a round wire, a wire having a conductor diameter of 100 μm to 5 mm is generally used. In the case of a rectangular wire, a wire having a length of one side of 500 μm to 5 mm is generally used.

The insulating layer may be a single layer or a multilayer. In the case where the insulating layer is a single layer, only an insulating layer formed by applying the polyimide resin varnish and baking the varnish functions as an insulating layer. In the case where the insulating layer is a multilayer, other insulating layers are formed before or after the formation of an insulating layer composed of the above polyimide. As a resin that forms the other insulating layers, any resin such as a polyimide, polyamide-imide, polyester imide, polyurethane, or polyether imide may be used.

Furthermore, the insulating layer preferably includes a surface lubricating layer as the outermost layer because processability is improved. Surface lubricating oil may be applied onto the outside of an insulated wire. In this case, an insertion property and processability are further improved.

FIG. 2 is a cross-sectional schematic view illustrating an example of an insulated wire of the present invention. A multilayered insulating layer is provided on the outside of a conductor 1. The insulating layer includes, from the conductor side, a first insulating layer 2, a second insulating layer 3, and a surface lubricating layer 4. For example, the first insulating layer 2 is formed by applying a polyamide-imide resin varnish containing an adhesion improver and baking the varnish, and the second insulating layer 3 is formed by applying the polyimide resin varnish of the present invention and baking the varnish. Note that the insulated wire of the present invention is not limited to this structure.

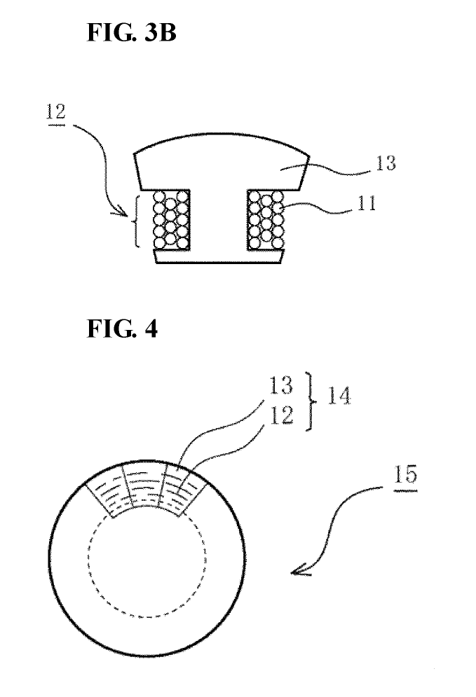

FIG. 3A is a schematic view illustrating an example of an electrical coil of the present invention. FIG. 3B is a cross-sectional view taken along line A-A′ of FIG. 3A. An electrical coil 12 is formed by winding an insulated wire 11 around the outside of a core 13 composed of a magnetic material. A component including a core and an electrical coil is used as a rotor or a stator of a motor. For example, as illustrated in FIG. 4, a stator 15 produced by combining and circularly arranging a plurality of split stators 14 each including a core 13 and an electrical coil 12 is used as a component of a motor.

### EXAMPLES

Next, the present invention will be described in more detail on the basis of Examples. It is to be understood that the scope of the present invention is not limited to the Examples.

### Examples 1 to 8 and Comparative Examples 1 to 6

### Preparation of Polyimide Precursor Resin

One or two aromatic diamines, whose types and amounts are shown in Table I and Table II, were dissolved in N-methylpyrrolidone, and an aromatic tetracarboxylic anhydride, whose type and amount are shown in Table I, was then added thereto. The resulting reaction mixture was stirred at room temperature in a nitrogen atmosphere for one hour. Subsequently, the reaction mixture was stirred at 60° C. for 20 hours to terminate the reaction, and was cooled to room temperature. Thus, a polyimide resin varnish was prepared. Note that the numerical values of the amount described in Table I are given in terms of molar ratio. The imide group concentration calculated from the molecular weights of the components is also shown in Table I.

### Preparation of Insulated Wire

The polyimide resin varnish was applied onto a surface of a conducting wire having a conductor diameter (diameter) of about 1 mm by an ordinary method and baked to form an insulating layer having a thickness of about 40 μm. Thus, insulated wires of Examples 1 to 8 and Comparative Examples 1 to 6 were prepared.

### Evaluation of Glass Transition Temperature

The conductor was removed from the insulated wire to prepare a tubular insulating layer. The glass transition temperature of the insulating layer was measured using a dynamic viscoelasticity measuring device (DMS) in a temperature range of 20° C. to 500° C. at a temperature increasing rate of 10° C./min.

### Evaluation of Mechanical Property

The conductor was removed from the insulated wire to prepare a tubular insulating layer. A tensile test was conducted using a tensile testing machine with a distance between chucks of 20 mm at a testing speed of 10 mm/min to measure an elongation at break.

### Measurement of Dielectric Constant

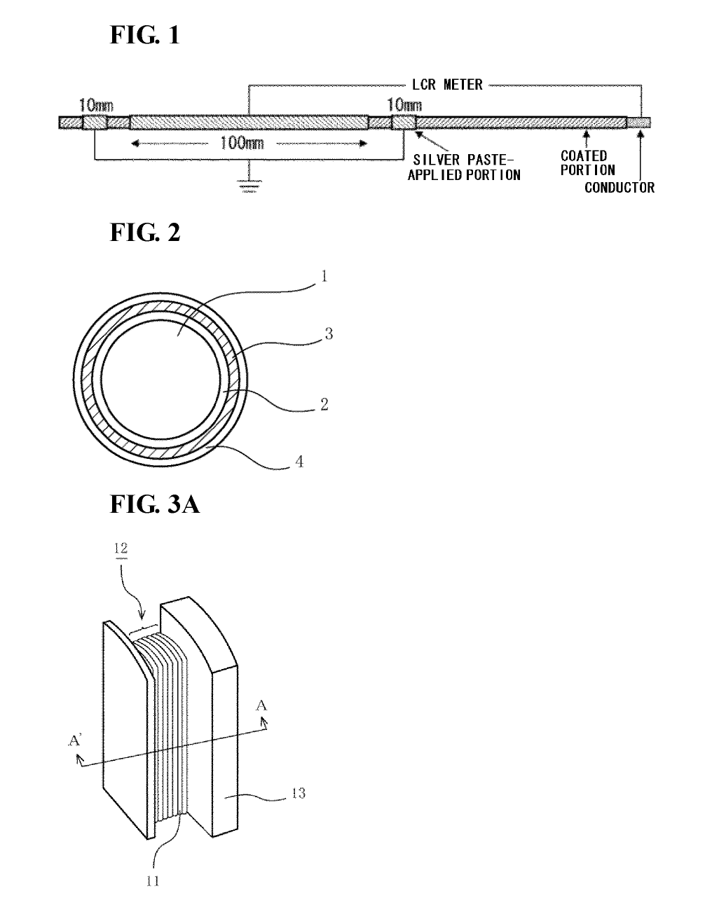

The dielectric constant of the insulating layer of each of the insulated wires was measured. As illustrated in FIG. 1, a silver paste was applied onto three positions on the surface of the insulated wire to prepare a sample for measurement (the width of the application was 10 mm at two positions at both ends, and the width of the application was 100 mm at a central position). The capacitance between the conductor and the silver paste was measured with an LCR meter. The dielectric constant was calculated from the measured value of the capacitance and the thickness of the coating film. The measurement was conducted at a temperature of 30° C. at a humidity of 50%. The evaluation results are shown in Tables I and II.

TABLE I

| | | | Example 1 | Example 2 | Example 3 | Example 4 | Example 5 | Example 6 | Example 7 | Example 8 |
|---|---|---|---|---|---|---|---|---|---|---|
| Acid anhydride | | PMDA | 100 | 100 | 100 | 100 | 100 | 100 | 100 | 100 |
| | | ODPA | | | | | | | | |
| Diamine | One benzene ring | PPD | | | | | | | | |
| | Two benzene | ODA | 50 | 25 | 50 | | 50 | 25 | | 50 |
| | rings | MDA | | | | 50 | | | 50 | |
| | | mTBHG | | | | | | | | |
| | Three or more | 4APBZ | 50 | | | | | | | |
| | benzene rings | BAPP | | | | | 50 | 75 | 50 | |
| | | TPE-Q | | 75 | 50 | 50 | | | | |
| | | TPE-R | | | | | | | | 50 |

| | | | | | | | | |
|---|---|---|---|---|---|---|---|---|
| Imide group concentration (%) | 25.8 | 31.3 | 33.1 | 33.2 | 30.1 | 26.9 | 30.2 | 33.1 |
| Glass transition temperature (° C.) | 320 | 321 | 323 | 330 | 324 | 303 | 326 | 337 |
| Elongation of coating film (%) | 125 | 130 | 119 | 103 | 139 | 178 | 109 | 111 |
| Dielectric constant | 3.0 | 2.9 | 3.0 | 3.1 | 3.1 | 2.9 | 3.0 | 3.0 |

TABLE II

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Acid anhydride | | PMDA | 100 | 100 | 100 | 100 | | 100 |
| | | ODPA | | | | | 100 | |
| Diamine | One benzene ring | PPD | | 50 | | | | |
| | Two benzene rings | ODA | 100 | | | | | |
| | | MDA | | | | | | |
| | | mTBHG | | | | | | 50 |
| | Three or more | 4APBZ | | | 100 | | | |
| | benzene rings | BAPP | | | | 100 | 100 | |
| | | TPE-Q | | | | | | |
| | | TPE-R | | 50 | | | | 50 |

| | | | | | | |
|---|---|---|---|---|---|---|
| Imide group concentration (%) | 36.6 | 35.7 | 23.1 | 23.6 | 20.4 | 36.7 |
| Glass transition temperature (° C.) | 398 | 349 | 329 | 316 | 238 | 340 |
| Elongation of coating film (%) | 95 | 85 | Cracking of | Cracking of | 151 | 75 |
| | | | coating film | coating film | | |
| Dielectric constant | 3.4 | 3.3 | 2.9 | 2.9 | 2.8 | 3.1 |

(Note)
mTBHG: 2,2′-dimethyl-4,4′-diaminobiphenyl

Polyimide coating films of Examples 1 to 8, in which an aromatic diamine having two benzene rings and an aromatic diamine having three or more benzene rings were used and the imide group concentration was 25% or more and 35% or less, each had a glass transition temperature of 300° C. or higher and an elongation of 100% or more of the coating film. Thus, both heat resistance and flexibility are satisfied. The dielectric constant was in the range of 2.9 to 3.1, which is lower than the dielectric constant of typical polyimide resins.

In Comparative Example 1, since an aromatic diamine having three or more benzene rings was not used, the elongation of the coating film was smaller than 100%, though the glass transition temperature was high. In Comparative Example 2, a first aromatic diamine having two benzene rings was not used, and paraphenylenediamine (PPD), which has one benzene ring, was used. Similarly to Comparative Example 1, the elongation of the coating film was small, though the glass transition temperature was high. In Comparative Example 3 and Comparative Example 4, only a second aromatic diamine having three or more benzene rings was used. The strength of the coating film was low, and cracks were formed. Consequently, the elongation of the coating film could not be measured.

In Comparative Example 5, similarly, only a second aromatic diamine having three or more benzene rings was used. In addition, 4,4′-oxydiphthalic dianhydride (ODPA), which has an aromatic ether bond in the molecule thereof, was used as an acid component, and thus the glass transition temperature was low and heat resistance was poor, though the elongation of the coating film was 100% or more. In Comparative Example 6, a first aromatic diamine having two benzene rings and a second aromatic diamine having three or more benzene rings were used in combination. However, since the imide group concentration was higher than 35%, the elongation of the coating film was smaller than 100% and thus flexibility was poor.

### REFERENCE SIGNS LIST

1 conductor

2 first insulating layer

3 second insulating layer

4 surface lubricating layer

11 insulated wire

12 electrical coil

13 core

14 split stator

15 stator

1. A polyimide resin varnish comprising, as a main component, a polyimide precursor resin obtained by allowing an aromatic diamine to react with an aromatic tetracarboxylic dianhydride,
wherein the aromatic diamine includes
a first aromatic diamine having an aromatic ether bond represented by formula (1) below and three or more in total selected from a benzene ring and a naphthalene ring, and
a second aromatic diamine represented by formula (2) below, and
an imide group concentration after imidization of the polyimide precursor resin is 25% or more and 35% or less: 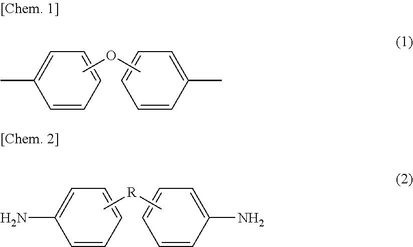
(where R in the formula represents CH₂ or O.)

2. The polyimide resin varnish according to claim 1, wherein the aromatic tetracarboxylic dianhydride is pyromellitic dianhydride.

3. The polyimide resin varnish according to claim 1, wherein the first aromatic diamine is at least one selected from the group consisting of 2,2-bis[4-(aminophenoxy)phenyl]propane, 1,1-bis[4-(4-aminophenoxy)phenyl]cyclohexane, 1,3-bis(4-aminophenoxy)benzene, and 1,4-bis(4-aminophenoxy)benzene.

4. The polyimide resin varnish according to claim 1, wherein a content ratio (molar ratio) of the first aromatic diamine to the second aromatic diamine is 30:70 to 90:10.

5. An insulated wire comprising a conductor and an insulating layer that covers the conductor either directly or with another layer therebetween, wherein the insulating layer is formed by applying the polyimide resin varnish according to any one of claims 1, and baking the polyimide resin varnish.

6. An electrical coil obtained by winding the insulated wire according to claim 5.

7. A motor comprising the electrical coil according to claim 6.
